(19) United States
(12) Patent Application Publication
(10) Pub. No.: US 2013/0086695 A1
(43) Pub. Date: Apr. 4, 2013

(54) METHOD AND SYSTEM FOR REMOTE ACCESS TO DATA STORED ON A HOST SYSTEM

(71) Applicant: Anantharaman Lakshminarayanan, Singapore (SG)

(72) Inventor: Anantharaman Lakshminarayanan, Singapore (SG)

(73) Assignee: ITWIN PTE LTD, Singapore (SG)

(21) Appl. No.: 13/627,329

(22) Filed: Sep. 26, 2012

(30) Foreign Application Priority Data
Sep. 26, 2011 (SG) 201106974-7

(51) Int. Cl. G06F 21/31

(52) U.S. Cl. CPC G06F 21/31
USPC 726/28

(57) ABSTRACT

A method and system for remote access to data stored on a host system from a remote system via a data link, a method and system for storing validation password data on a pair of connected first and second modules, and a method and system for verifying the identity of a first module removed from a pair of initially connected and associated first and second modules.

### FIELD OF INVENTION

Embodiments of the present invention relate broadly to a method and system for remote access to data stored on a host system from a remote system via a data link, to a method and system for storing validation password data on a pair of connected first and second modules, and to a method and system for verifying the identity of a first module removed from a pair of initially connected and associated first and second modules.

### BACKGROUND

Systems and methods for remote access to data stored on a host system are known in the art. One existing approach provides a portable system and method to access data remotely. The system includes a first module and a second module, each of the modules being associated with a host system. The first module is capable of being connected to the host system and the second module, and the second module is capable of being connected to the remote system to establish a secure communication channel between the first and second modules across a data link to access the data.

However, such conventional systems and methods potentially suffer from security issues. For example, in the above approach, if the owner loses the second module, and does not have a quick physical access to remove the first module that is attached to the host system, anyone who finds the second module can access the files in the host system.

One existing solution to the above problem involves setting a local password for each of the modules. Typically, this involves the user entering a password and generating a password hash, which is a one-way function (e.g. a check sum) of the password and a SALT value (a randomly generated value).

However, in existing implementations, the SALT value and the password hash are locally stored on the same device. Thus, an attacker who is able to extract the SALT and the password hash can thus mount a dictionary attack, extract the password, and then access the resources on the respective module, as well as data shared on the host system.

Another existing solution involves maintaining a password database for web-based log-in to the respective modules. Typically, the password database is in the form of a tuple containing the log-in ID, SALT value and password hash, and tuple information is usually stored on a server. However, if the server is hacked, the attacker can mount dictionary attacks on all entries in the compromised password database.

A need therefore exists to provide a method that seeks to address one or more of the above problems.

### SUMMARY

In accordance with a first aspect of the present invention, there is provided a method for remote access to data stored on a host system from a remote system via a data link, the method comprising the steps of:
connecting a first module and a second module to the host system, the first module initially being connected to and associated with the second module;
storing validation password data for verifying the identity of the first module on the second module; and
upon connecting the removed first module to the remote system to establish a secure communication channel between said first and second modules across said data link to access said data, the host system having the second module connected thereto, entering a user password for generating user password data for verification by the second module based on the stored validation password data.

The step of storing validation password data for verifying the identity of the first module on the second module may comprise:
providing a validation password;
generating random first and second SALT values;
calculating a first password hash based on the validation password and the first SALT value, and a second password hash based on the validation password and the second SALT value; and
storing the first SALT value and the second password hash on the second module.

The second SALT value and the first password hash may be stored on the first module.

The step of calculating the first and second password hashes may be performed at the host system.

The step of calculating the first and second password hashes may be performed at either the first module or the second module.

Generating the user password data may comprise calculating a third password hash based on the user password entered and the second SALT value stored on the first module.

The verification by the second module may comprise:
receiving the third password hash transmitted from the first module via the data link;
comparing the third password hash with the second password hash stored on the second module; and
confirming the identity of the first module only if the third password hash is identical to the second password hash.

The method may further comprise entering another user password for another verification attempt if the third password hash is considered not identical to the second password hash by the second module.

No further verification attempt may be allowed after a predetermined number of failed verification attempts.

Each password hash may be calculated using a respective one-way function.

The first and second SALT values each may have a length of about 20 bytes.

In accordance with a second aspect of the present invention, there is provided a method of storing validation password data on a pair of connected first and second modules, the method comprising the steps of:
associating the first module with the second module; and
storing validation password data for verifying the identity of the first module on the second module.

In accordance with a third aspect of the present invention, there is provided a method of verifying the identity of a first module removed from a pair of initially connected and associated first and second modules, the method comprising the steps of:
receiving, at the second module, user password data generated at and transmitted from the first module via a data link; and
verifying said user password data based on validation password data stored on the second module.

In accordance with a fourth aspect of the present invention, there is provided an access system for providing remote access to data stored on a host system from a remote system via a data link, the access system comprising the remote system and the host system, wherein:
the host system is configured to connect to a first module and a second module, the first module initially being connected to and associated with the second module, and to store validation password data for verifying the identity of the first module on the second module; and
the remote system is configured to, upon connecting the removed first module to the remote system to establish a secure communication channel between said first and second modules across said data link to access said data, the host system having the second module connected thereto, enter a user password for generating user password data for verification by the second module based on the stored validation password data.

In accordance with a fifth aspect of the present invention, there is provided a host system for storing validation password data on a pair of connected first and second modules, the host system configured to associate the first module with the second module; and store validation password data for verifying the identity of the first module on the second module.

In accordance with a sixth aspect of the present invention, there is provided a host system for verifying the identity of a first module removed from a pair of initially connected and associated first and second modules, the host system configured to receive user password data generated at and transmitted from the first module via a data link; and verify said user password data based on validation password data stored on the second module being connected to the host system.

In accordance with a seventh aspect of the present invention, there is provided a data storage medium having stored thereon computer code means to instruct a computing device to execute a method of storing validation password data on a pair of connected first and second modules, the method comprising the steps of:
associating the first module with the second module; and
storing validation password data for verifying the identity of the first module on the second module.

In accordance with an eighth aspect of the present invention, there is provided a data storage medium having stored thereon computer code means to instruct a computing device to execute a method of verifying the identity of a first module removed from a pair of initially connected and associated first and second modules, the method comprising the steps of:
receiving, at the second module, user password data generated at and transmitted from the first module via a data link; and
verifying said user password data based on validation password data stored on the second module.

In accordance with a ninth aspect of the present invention, there is provided a data storage medium having stored thereon computer code means to instruct an access system to execute a method of providing remote access to data stored on a host system from a remote system via a data link, the access system comprising the remote system and the host system, wherein the method comprises the steps of:
connecting a first module and a second module to the host system, the first module initially being connected to and associated with the second module;
storing validation password data for verifying the identity of the first module on the second module; and
upon connecting the removed first module to the remote system to establish a secure communication channel between said first and second modules across said data link to access said data, the host system having the second module connected thereto, entering a user password for generating user password data for verification by the second module based on the stored validation password data.

### BRIEF DESCRIPTION OF THE DRAWINGS

FIG. 1 illustrates one embodiment of a system for providing secure, seamless file sharing between a host computer and a remote computer according to the prior art;

FIG. 2A illustrates an alternate embodiment of a system for providing secure, seamless file sharing between a host computer and a remote computer according to the prior art;

FIG. 2B illustrates the device of FIG. 2A showing the two hardware modules in a disconnected state;

FIG. 3A illustrates the connection of the system of FIGS. 1 and 2 to a host system;

FIG. 3B illustrates the separate connections of two hardware modules associated with the system of FIGS. 1 and 2;

FIG. 4 shows a block diagram illustrating the password information stored on respective hardware modules of the system of FIGS. 1 and 2;

FIG. 5 shows a flow chart illustrating a method of setting up the system of FIGS. 1 and 2;

FIG. 6 shows a flow chart illustrating a method of operating a portion of the system of FIGS. 1 and 2 on a remote computer system;

FIG. 7 shows a flow chart 700 illustrating a method of setting a password in accordance with an example embodiment.

FIG. 8 shows a flow chart illustrating a method of verifying a password set earlier based on the method of FIG. 7, according to an example embodiment; and

FIG. 9 illustrates one example of a computer system that can be used with the system and method of an example embodiment.

FIG. 10 shows a flow chart illustrating a method for remote access to data stored on a host system from a remote system via a data link according to an example embodiment.

FIG. 11 shows a flow chart illustrating a method of storing validation password data on a pair of connected first and second modules according to an example embodiment.

FIG. 12 shows a flow chart illustrating a method of verifying the identity of a first module removed from a pair of initially connected and associated first and second modules according to an example embodiment.

### DETAILED DESCRIPTION OF THE PREFERRED EMBODIMENTS

Embodiments of the present invention provide a system and method for allowing a user to securely access data stored on a first system from a remote system. It is understood that the first and remote systems can be any computing device capable of making a remote connection. For example, the first system may be a home or office computer system, a PDA, etc. The remote connection can be, by way of example and not limitation, an internet connection, a LAN or WAN connection, an IR, blue-tooth, short-range radio channels such as Bluetooth, UWB, Wi-Fi, long-range radio channels such as GSM, GPRS, 3G, proprietary radio connections, or even wired connections such as optical links. For ease of discussion, the first system will be referred to as the host system, while the remote system will be referred to as the remote computer.

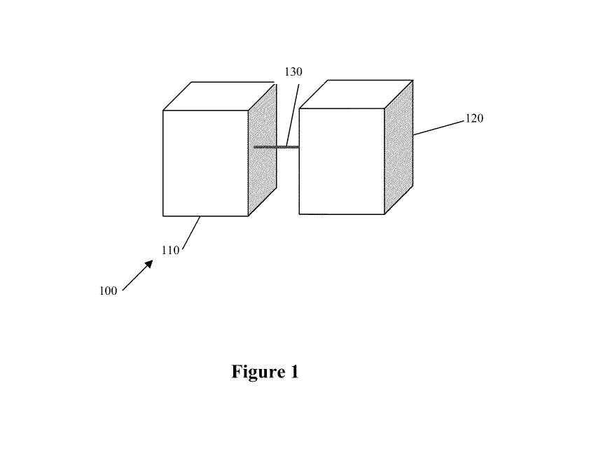

FIG. 1 illustrates one embodiment of a system 100 according to the prior art which may be used with the method of the present invention. One example of system 100 has been described in International Publication No. WO 2009/131538, the contents of which are hereby incorporated by cross-reference. System 100 includes a first hardware module 110 and a second hardware module 120. The modules 110, 120 can be connected to each other via a connection 130. The module 110 is configured to be connected to a host system, while the module 120 is configured to be connected to a remote system.

The connection 130 between the modules 110, 120 and the respective systems may be made, by way of example and not limitation, using a physical electrical interface. The connection 130 may be established such that the user connecting module 110 and module 120 is absolutely sure that these two modules are connected. The physical electrical interface may include, but is not limited to a standard USB connector, a firewire connector, a serial interface, a parallel interface, a physical cable, a proprietary electrical connection, and a network interface. Alternately, the connection between the modules 110, 120 may be any type of electromagnetic signal-based communication (i.e. infrared, radio frequency, microwave, Bluetooth, 3G, 4G, GSM etc.).

When the connection 130 is based on electromagnetic signal-based communication such as radio, then the two modules 110 and 120 can have attributes that the user knows that will enable him to know that modules 110 and 120 are being connected (when they are being connected). For example, the manufacturer of system 100 can ensure that only modules 110 and 120 of system 100 are unique to each other, and can be connected to each other and no other modules.

In some embodiments, the modules 110, 120 receive electrical power from the respective systems. In alternate embodiments, the modules 110, 120 may contain an independent power source.

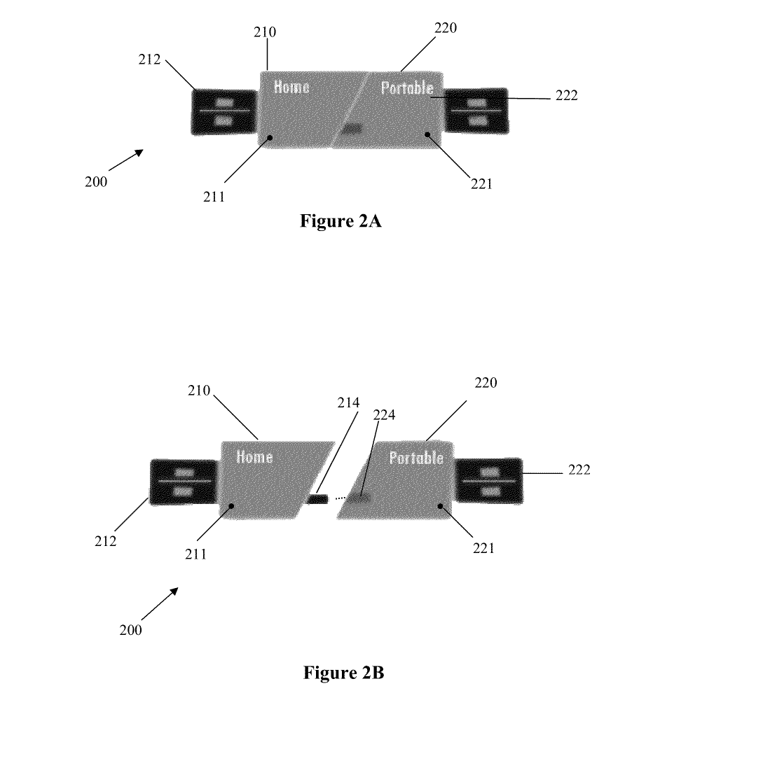

FIG. 2A illustrates a USB system 200 that provides a specific operational implementation of the system 100. While the following discussion will outline the use of the USB system 200, it is understood as discussed above that many other types of connections besides USB can also be used. The USB system 200 includes a HomeUSB 210 and a PortableUSB 220 each having its own male USB connector 212, 222 respectively. In this embodiment, the HomeUSB 210 is the master device. However, it is understood that the requisite software may be resident on both the HomeUSB 210 and PortableUSB 220. Whichever device is connected to the host system 330 (see below) may become the HomeUSB 210.

FIG. 2B shows the HomeUSB 210 and PortableUSB 220 in a disconnected state. As shown in this Figure, the HomeUSB 210 can be connected to the PortableUSB 220 by way of a male connector 214. PortableUSB 220 includes a corresponding female connector 224. The various operations of the USB system 200, the HomeUSB 210 and the PortableUSB 220 are described below. As discussed above with reference to FIG. 1, it is understood that the connectors 214, 224, which correspond to connection 130, are provided by way of example only.

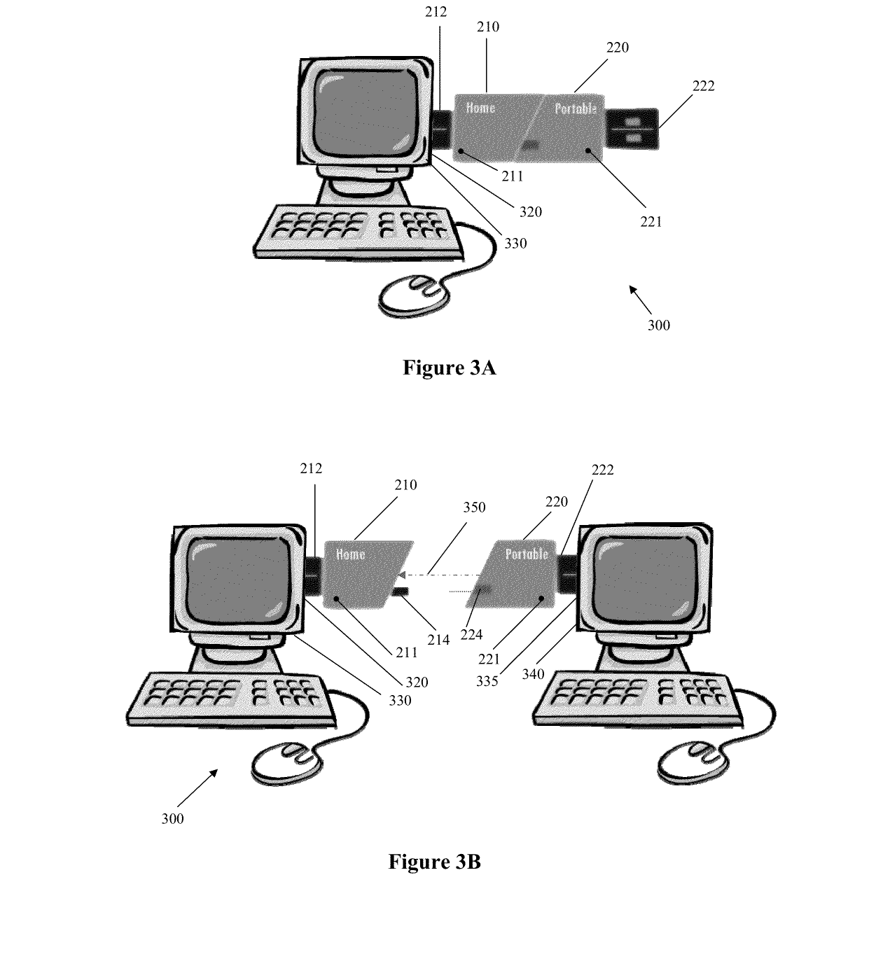

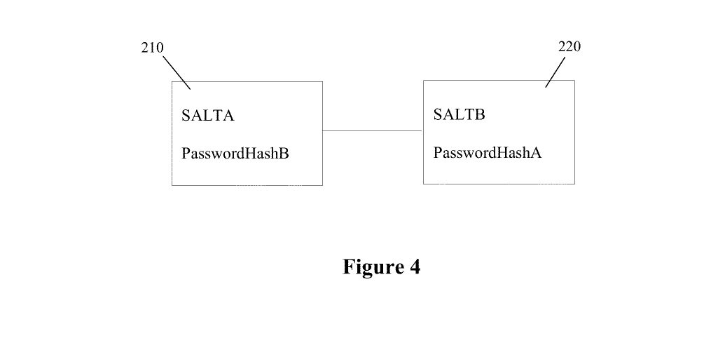

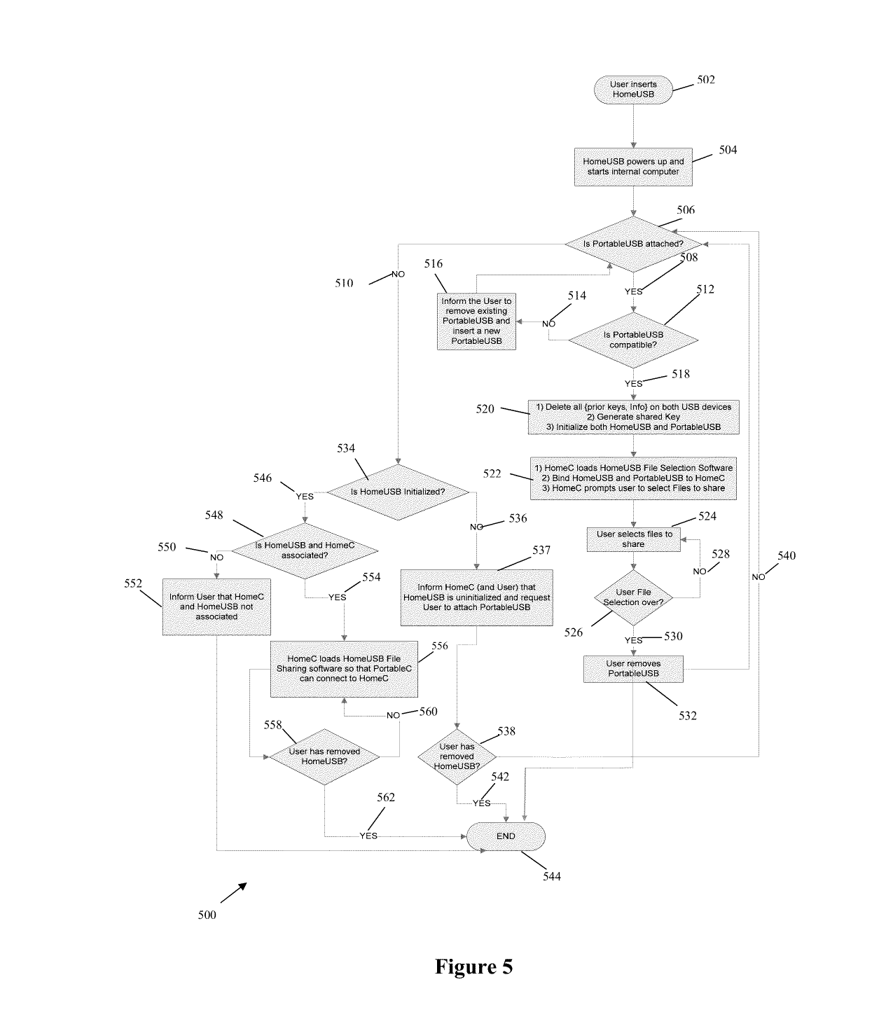

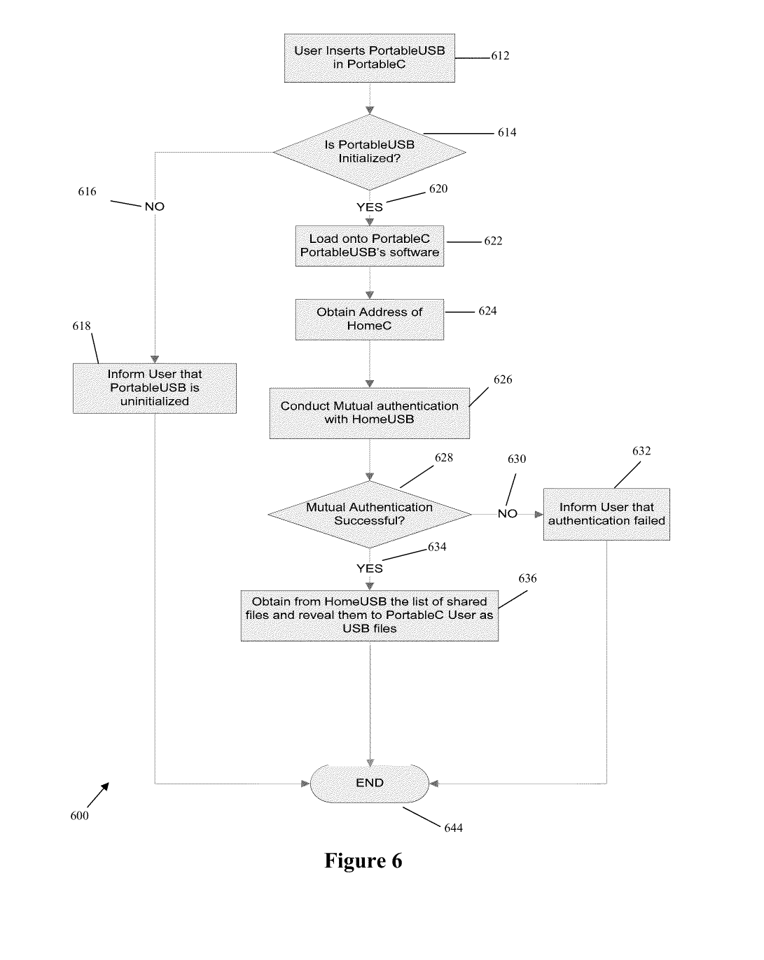

As will be explained in more detail below with reference to FIGS. 3-7, the system 200 allows a user to initiate a secure connection between the host computer and the remote computer. The system 200 provides hardware encryption and authentication. A user can insert the system 200 into a USB slot on a host computer (see FIGS. 3 and 4). A user selects files to be shared from the host computer, and the software on the HomeUSB 210, which is loaded onto the host computer, virtually copies the selected files onto the HomeUSB 210. The PortableUSB 220 is then removed, leaving the HomeUSB 210 plugged into the host computer, and connected to a network. The user inserts the PortableUSB 220 into a USB slot on a remote system. Software is downloaded onto the remote system from the PortableUSB 220, and a secure connection is established between the remote computer and the home computer, allowing the user to securely retrieve any of the files that were virtually copied onto the HomeUSB 210. A detailed discussion of the process is provided below with reference to FIGS. 5 and 6.

The HomeUSB 210 and PortableUSB 220 may contain integrated circuit (IC) chips, which are tamper-resistant. These IC chips may have pre-stored operating systems (OS) and software. Specific details concerning the operation of the system 200, the HomeUSB 210 and the PortableUSB 220 are discussed below. The OS as discussed above can be any known OS. Examples of such OS can include, but are not limited to Disk Operating System (DOS)-based, Microsoft Windows®-based, Linux®-based, Novell Netware® CD-based, Apple MAC®-based, proprietary OS's, and the like.

In some embodiments, the HomeUSB 210 and PortableUSB 220 may have markings, LED lights, audio cues or other indicators (not shown) to show that the HomeUSB 210 and PortableUSB 220 are compatible. The indicators allow a user who, for example, has multiple home computers to access each of them individually using a separate system 100, 200. In alternate embodiments, a single PortableUSB 220 may be used to access multiple HomeUSBs 210. In other alternate embodiments, multiple PortableUSBs 220 may access a single HomeUSB 210. Similarly, multiple HomeUSBs 210 may access and be accessed by multiple PortableUSBs 220. In alternate embodiments, the HomeUSB 210 and Portable 220 may have indicators 211, 221 to indicate their status. For example, when using LED lights for indicators 211, 221, red lights may indicate data is being transferred, while a change in light colors from red to green may indicate completion of the data transfer etc.

FIG. 3A illustrates one embodiment of a system 300, capable of using the system 100, 200. In this embodiment, the connector 212 of the system 200 is plugged into a corresponding port 320 of a host system 330. The specific operation of the system 200 with the host system 330 is discussed below with respect to FIG. 5.

FIG. 3B illustrates an expanded version of the system 300 that uses the USB system 200. The connector 222 of the PortableUSB 220 has been inserted into a corresponding port 335 of a remote system 340. Once the PortableUSB 220 has been inserted, the remote system 340 establishes a connection 350 with the host system 330 to access the data that was selected and stored on the HomeUSB 210. In some embodiments, the connection 350 may be an Internet connection. However, the connection may be any type of hard wired, optical, or wireless connection known to those of skill in the art.

FIG. 5 illustrates one embodiment of a flowchart showing one method, designated generally as reference numeral 500, for connecting and operating the system 100, 200. While the following process discussion uses the embodiment of the system 200 described above, it is understood that similar steps apply regardless of the specific hardware and connections that are used. As previously stated, all configurations of the systems 100, 200, and 300 are deemed to fall within the scope of the present invention. In FIGS. 5 and 6, the host system 330 is designated as the HomeC, while the remote system 340 is designated as the Portable C.

The method 500 begins with a user inserting the connector 212 of the HomeUSB 210 into the corresponding port 320 of the host system 330, as shown with reference numeral 502. In an example embodiment, the host system 330, running on an operating system installed by the user, may have a pre-installed USB software module that effects initialization between the host system 330 and the HomeUSB 210. For example, Windows® based operating systems will detect the insertion of the HomeUSB 210. In some applications, the operating system on the host system 330 may also automatically execute programs stored on the HomeUSB 210. Programmers skilled in USB programming will be familiar with this type of programming.

The HomeUSB 210 then powers up and initializes one or more internal software modules, as shown with reference numeral 504. These software modules allow the HomeUSB 210 to determine if the PortableUSB 220 is attached, as shown with reference numeral 506. At this time, one or more of the software modules stored on the HomeUSB 210 may also be loaded onto the host system 330 to allow various communications from the HomeUSB 210 and PortableUSB 220 to be displayed to the user. The PortableUSB 220 may also have one or more internal software modules that communicate with the HomeUSB 210 and/or the host system 330. Using the initialized software modules on the HomeUSB 210 and PortableUSB 220, if the PortableUSB 220 is attached, as shown with reference numeral 508, the HomeUSB 210 checks to see if the PortableUSB 220 is compatible, as shown with reference numeral 512. As discussed above, it is possible to configure the system 200 such that a single HomeUSB 210 is compatible with only one PortableUSB 220, thus providing an added measure of security to prevent unauthorized access to the data that the user wishes to protect. Alternately, multiple PortableUSBs 220 may be configured for a single HomeUSB 210, as previously discussed. The situation where the PortableUSB 220 is not attached is described in more detail below.

If the PortableUSB 220 is not compatible, as shown with reference numeral 514, the user is instructed to remove the PortableUSB 220 and insert an alternate/correct PortableUSB 220, as shown with reference numeral 516. Step 506 is then repeated. If the PortableUSB 220 is compatible, as shown with reference numeral 518, the system 200 then deletes all prior association information contained on both the HomeUSB 210 and PortableUSB 220, generates a shared key, and initializes both the HomeUSB 210 and PortableUSB 220, as shown with reference numeral 520.

When a HomeUSB 210 and PortableUSB 220 are paired together and powered, they become “initialized”. In the “initialized” state, the HomeUSB 210 and PortableUSB 220, using the various software modules discussed above, are physically bound to the host system 330 (and user login-ID) that it is associated with. The physical binding is enforced using unique computer identifiers, e.g. the MAC address, Hard-disk ID, etc. on desktop computers. After initialization, the HomeUSB 210, the PortableUSB 220 and host system 330 all share a randomly selected long system pairing identifier, PI, that is generated using the software modules loaded onto the HomeUSB 210. In a preferred embodiment, the PI is at least 20-Bytes long. In some embodiments, an initialized HomeUSB 210 can be un-initialized and then freshly re-initialized by pairing with a new PortableUSB 220. The HomeUSB 210 and PortableUSB 220 can also be un-initialized using software, e.g. a user could right click on a USB file system icon on the desktop and select the de-initialize option.

After initialization of the system 200, and using one or more of the software modules discussed above, the HomeUSB 210 and PortableUSB 220 share a MASTER Key, the network address of the host system 330, and the randomly selected system 200 Pairing Identification number. In some embodiments, the HomeUSB 210 and PortableUSB 220 may also share encrypted selected file set information. Similarly, after initialization, the HomeUSB 210 and host system 330 share the randomly selected system 200 Pairing Identification number and the host system's 330 unique computer identifier. The computer identifiers may be derived from one or more of the host system's 330 hardware and software identifiers. These can include, but are not limited to, the hard-disk ID (a unique number for every hard disk), the MAC address (a unique number associated with every network interface card), and/or a user Login-ID. A specific discussion of the procedures involved in these steps, and of the use of encryption keys in general, is provided below.

Once the HomeUSB 210 and PortableUSB 220 are initialized, a software module residing on the HomeUSB 210 directs the host system 330 to load the file selection software stored on the HomeUSB 210, associates (binds) the HomeUSB 210 and PortableUSB 220 to the host system 330, and prompts the user to select the files that the user wishes to make available for access from the remote system 340, as shown with reference numeral 522. The user then selects the files, as shown with reference numeral 524. The host system 330 then prompts the user to determine if the file selection process has been completed, as shown with reference numeral 526. If selection is not completed, as shown with reference numeral 528, steps 524 and 526 are repeated. If selection has been completed, as shown with reference numeral 530, the user is then prompted to remove the PortableUSB 220, as shown with reference numeral 532. Upon unplugging the PortableUSB 220 from the remote system 340, the software module that facilitates the connection between the HomeUSB 210 and PortableUSB 220 will terminate. This ends the initial setup, as shown with reference numeral 544.

In some embodiments, if the operating system of the host system 330 does not detect the insertion of the HomeUSB 210 into a corresponding port, or if the software modules loaded onto the host system 330 are not set to automatically initiate the programs stored on the HomeUSB 210 and/or PortableUSB 220, the user may manually start the process discussed above. As previously stated, the HomeUSB 210 and PortableUSB 220 may contain software modules that facilitate connection to a number of different operating systems. In a preferred embodiment, once the HomeUSB 210 is inserted into the host system 330, all of the steps concerned with initializing the devices, associating the HomeUSB 210, PortableUSB 220, and host system 330, generating the key information, and launching the file selection software, are performed automatically. The user simply needs to insert the HomeUSB 210 into the host system, and the selection software will appear allowing the user to select the desired files.

As previously discussed, in the embodiment illustrated in FIG. 5, the file selection step 524 is a virtual selection, i.e. no files are actually copied onto the HomeUSB 210. A map, data path, or shortcut is established on the HomeUSB 210 to the specific files on the host computer 330. In alternate embodiments, actual file transfer may occur, and copies of the selected files may be encrypted and stored on the HomeUSB 210. In some embodiments, actual copies of the selected files, which may be encrypted using one or more software encryption modules discussed above, may be stored on the PortableUSB 220. In some embodiments, the PortableUSB 220, via the remote system 340, can only access data from the host system 330 that has been copied to the HomeUSB 210.

Returning to step 506, if the PortableUSB 220 is not attached to the HomeUSB 210, as shown with reference numeral 510, the software modules running on the HomeUSB 210 perform a check to determine if the HomeUSB 210 has been initialized, as represented by reference numeral 534. If the HomeUSB 210 has not been initialized, as represented by reference numeral 536 (see step 520), the system informs the user that the HomeUSB 210 has not been initialized, and requests the user to connect the PortableUSB 220, as shown with reference numeral 537.

At this point, the system then checks to determine if the user has removed the HomeUSB 210, as represented by reference numeral 538. If the user removes the HomeUSB 210, as represented with reference numeral 542, the process ends, as represented with reference numeral 544. If the user does not remove the HomeUSB 210, as represented by reference numeral 540, step 506 is then repeated. The user thus has the option of attaching the PortableUSB 220, and restarting the process from step 506, or removing the HomeUSB 210, attaching the PortableUSB 220 external to the host system 330, and restarting the process from step 502.

Returning to step 534, if the HomeUSB 210 has been initialized, as represented by reference numeral 546, the system 200 checks to determine if the HomeUSB 210 and the host system 330 have been previously associated (see step 522). This process ensures that a HomeUSB 210 that has been previously associated with another computer is not inserted into an incorrect host system 330 in error. This allows a user to remove the associated HomeUSB 210, for example, to restrict all access to the data on the host system 330, and still re-connect the HomeUSB 210 at a later time to reinstate the access without needing to regenerate keys, etc. In alternate embodiments, it is possible to associate a single HomeUSB 210 with multiple host systems 330.

If the HomeUSB 210 and host system 330 are not associated, as represented by reference numeral 550, the system informs the user that the two are not associated, as represented by reference numeral 552, and the process ends, as represented by reference numeral 544. In a preferred embodiment, the association process will only take place when both the HomeUSB 210 and PortableUSB 220 are connected as a unitary system 200 to the host system 330.

If the HomeUSB 210 and host system 330 were previously associated, as represented by reference numeral 554, the host system 330 loads the file sharing software located on the HomeUSB 210 to facilitate the remote connection between the host system 330 and the remote system 340, as represented by reference numeral 556. The system will periodically check to ensure that the HomeUSB 210 is still connected to the host system 330, as represented by reference numeral 558. If the HomeUSB 210 is no longer connected, as represented by reference numeral 562, the process ends, as represented by reference numeral 544. As long as the connection is maintained, as represented by reference numeral 560, the files will be available to the user via the PortableUSB 220 connected to the remote system 340. This connection will be discussed in more detail below with reference to FIG. 6.

FIG. 6 illustrates one embodiment of a flowchart showing one method, designated generally as reference numeral 600, for connecting the PortableUSB 220 to the remote system 340 and viewing the files previously selected. It is understood that the PortableUSB 220 discussed here has already been initialized along with the HomeUSB 210, and appropriate encryption algorithms applied, as discussed above with respect to FIG. 5.

The method 600 begins with the user inserting the PortableUSB 220 into the remote system 340, as shown with reference numeral 612. Using the software resident on the PortableUSB 220, a determination is made as to whether or not the PortableUSB 220 has been initialized, as shown with reference numeral 614. If the PortableUSB 220 has not been initialized, as shown with reference numeral 616, the PortableUSB 220 informs the user that the PortableUSB 220 is not initialized, as shown with reference numeral 618, and the process ends, as shown with reference numeral 644.

If the PortableUSB 220 has been initialized, as shown with reference numeral 620, one or more software modules that are pre-loaded in the PortableUSB 220 are then loaded onto the remote system 340, as shown with reference numeral 622. These modules are designed to facilitate the connection between the PortableUSB 220 and the remote system 340, and between the PortableUSB 220 and the HomeUSB 210. The remote system 340 then obtains the address of the host system 330, as shown with reference numeral 624.

When the HomeUSB 210 and PortableUSB 220 are initialized and physically bound to the host system 330, the software that is pre-loaded onto the host system 330 will retrieve the address of the host system 330. This software module will pass the address of the host system 330 to the HomeUSB 210. The HomeUSB 210 will then pass the address of the host system 330 to the PortableUSB 220. As previously discussed, the address mentioned herein can be an IP address or an address pointer.

When an address pointer is stored on the PortableUSB 220 during the initialization phase of the HomeUSB 210 and the PortableUSB 220, the IP address (or network address) of the host system 330 is stored along with the address pointer. The address pointer is the pairing identifier. When a user wants to retrieve files stored on the host system 330 from the remote system 340, the user then inserts the PortableUSB 220 in the remote system 340. The various software modules stored on the PortableUSB 220 are first loaded onto the remote system 340. These software modules execute code to retrieve the network address of the host system 330 or the address pointer. If the IP address of the host system 330 is available, the remote system 340 can make a connection directly with the host system 330. If the address pointer is available instead, the remote system 340 firsts retrieves the IP address and then connects to the host system 330.

Mutual authentication between the PortableUSB 220 and the HomeUSB 210 can then be conducted, as shown with reference numeral 626 and described above. A determination is then made as to whether or not the mutual authentication is successful, as shown with reference numeral 628. If the authentication is not successful, as shown with reference numeral 630, the user is informed that authentication has failed, as shown with reference numeral 632, and the process ends, as shown with reference numeral 644.

If the authentication is successful, as shown with reference numeral 634, the list of shared files is obtained from the HomeUSB 210 and shown to the user of the remote system 340, as shown with reference numeral 636. The user can access and work with the files that he has selected on the HomeUSB 210. The process then ends, as shown with reference numeral 644. As discussed above, the connection between the HomeUSB 210 and the remote system 340 via the PortableUSB 220 can be maintained as long as desired. The user of the remote system 340 may terminate the connection at any time. Termination may be effected by, for example, using the software provided on the PortableUSB 220, or by removing the PortableUSB 220 from the system 340. Similarly, a user at the host system 330 may terminate the connection.

In a preferred embodiment, the software available on the system 200 allows the system to operate seamlessly with respect to the user. When the HomeUSB 210 and PortableUSB 220 are combined into the system 200, a system software module may be loaded onto the host system 330. The system software module may perform system 200 initialization, and Selected File Set (SFS) selection as discussed above. Similarly, after the system 200 is initialized and the PortableUSB 220 is removed, a HomeUSB software module may be loaded onto the host system 330. This module may perform authentication with the PortableUSB 220, and authorization and transfer of the selected shared files. Additionally, when the PortableUSB 220 is inserted into the remote system 340, a PortableUSB software module may be loaded. This module may perform authentication with the HomeUSB 210, and obtain the shared files previously identified.

There are many alternate applications of the system 200 described above. For example, once the system has been initialized, it is possible to let the PortableUSB serve as the HomeUSB for the original HomeUSB. Effectively, the HomeUSB and PortableUSB switch roles. This enables the user to access files on the PortableUSB while using the HomeUSB. Additionally, it may be possible to use just one hardware module (portable), and replace the HomeUSB with a software module. The user needs to install the virtual HomeUSB module however, and manage it using software. Similarly, it is possible to use a third device such as a mobile phone to serve as the PortableUSB.

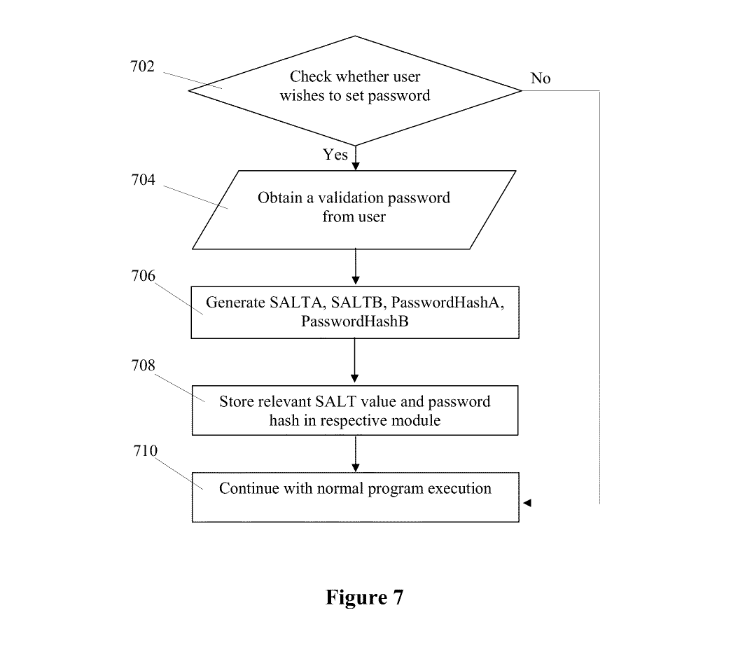

Further, in the example embodiments, additional security features in the form of a password scheme are implemented to prevent an attacker from accessing the host system in the event that one of the modules, e.g. the PortableUSB 220, is lost or stolen. Generally, when the user inserts the system 200 (comprising the HomeUSB 210 and the PortableUSB 220) into the host system 330 (referred to in FIG. 5 as HomeC) for initialization, any old password is deleted. The user has the option of setting a new password. The system then checks whether the password that has been entered is valid, and the valid password information is stored, as discussed in detail below with reference to FIG. 7.

FIG. 7 shows a flow chart 700 illustrating a method of setting the password in accordance with an example embodiment. For example, the password setting may be performed during or after step 520 of FIG. 5. At this point, an association between the HomeUSB 210 and the PortableUSB 220 has been created, and the HomeUSB 210 and the PortableUSB 220 share a secret (e.g. the MASTER KEY) which is used to encrypt all data communication between the HomeUSB 210 and the PortableUSB 220, or between the host system 330 and the remote system 340. It will be appreciated, however, that the password setting may be carried out at other suitable points during the initialization stage.

Referring to FIG. 7, at step 702, the system checks whether the user wishes to set a password, e.g. by displaying a dialogue box for the user to select. If the user chooses “Yes”, at step 704, a validation password is obtained from the user. In an example embodiment, this is done by scanning and checking the password entered by the user against pre-determined requirements, e.g. password length, presence or lack of special characters, etc. If the password entered by the user is deemed not suitable, the system prompts the user to enter another password, until a suitable validation password is obtained.

On the other hand, if the user chooses “No” at step 702, the password setting stage ends, preferably with a warning to the user that password protection has not been enabled.

At step 706, two random SALT values (SALTA and SALTB) and two password hashes (PasswdHashA and PasswdHashB) are generated. The SALT values are preferably about 20 bytes in length. The generation of the two password hashes (PasswdHashA and PasswdHashB) is identical to the password hash generation process for local verification. For example, PasswordHashA is a one-way function of the password obtained in step 704 and SALTA. Similarly, PasswordHashB is a one-way function of the password obtained in step 704 and SALTB.

In some embodiments, e.g. where the HomeUSB 210 and PortableUSB 220 have relatively low computing power, step 706 above is performed more economically by the host system 330. In a preferred embodiment, step 706 above is performed directly by either the HomeUSB 210 or the PortableUSB 220 such that the SALT values and the password hashes are not disclosed to any external system except the HomeUSB 210 and the PortableUSB 220.

At step 708, the relevant SALT value and password hash are stored on the respective module. In the example embodiment, SALTB and PasswdHashA are stored on the PortableUSB 220, while SALTA and PasswdHashB are stored on the HomeUSB 210. That is, the validation password data, here in the form of the password hash, for verifying the identity of one module is stored on the other module, and vice versa. FIG. 4 shows a block diagram illustrating the password data stored on the HomeUSB 210 and the PortableUSB 220, as described in step 708.

After the password data has been stored, normal program execution continues, as shown by step 710. For example, step 522 of FIG. 5 is then carried out.

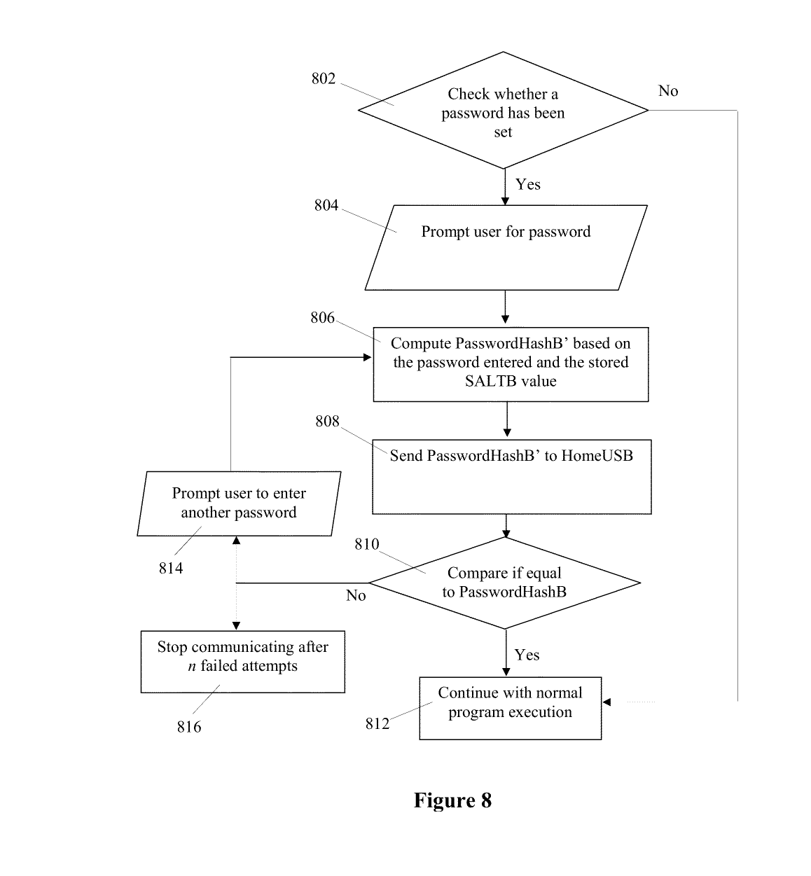

Subsequently, when the user inserts a password-enabled module into e.g. the remote system 340, a password is requested. If a correct password is entered, connection and access to e.g. the host system 330 are provided, as described above. If an incorrect password is entered, the user is prompted to remove the module and try again. This is discussed in detail below with reference to FIG. 8.

FIG. 8 shows a flow chart 800 illustrating a method of verifying a password set earlier based on the method of FIG. 7, according to an example embodiment. For example, the password verification process may be performed after or as part of the authentication step 626 of FIG. 6. In the example shown by FIG. 8, the password verification process is described with respect to a situation where the user wants to access files on the host system 330 (with the HomeUSB 210 inserted) using the remote system 340 (with the PortableUSB 220 inserted). It should be appreciated that a similar password verification process may be applicable if another user wishes to access files on the remote system 340 using the host system 330.

Referring to FIG. 8, at step 802, a check whether a password has been set, is performed. If the result is “Yes”, at step 804, the software application prompts the user to enter the password for verification. On the other hand, if the result is “No”, normal program execution, e.g. other steps of the authentication stage, continues (as shown by step 812).

At step 806, a PasswordHashB′ is computed based on the password entered by the user and the SALTB value stored on the PortableUSB 220 (the storing is described above in step 708 of FIG. 7). At step 808, the computed PasswordHashB′ is sent via the data link to the host system 330, which, in turn, sends it to the HomeUSB 210 for verification.

At step 810, the computed PasswordHashB′ is compared against the PasswordHashB stored on the HomeUSB 210 (the storing is described above in step 708 of FIG. 7). If PasswordHashB′ is identical to PasswordHashB, password verification is successful and normal program execution continues, as shown by step 812. For example, the HomeUSB 210 informs the software application on the host system 330 that access to relevant files shared on the host system 330 from the remote system 340 is allowed.

On the other hand, if PasswordHashB′ is not identical to PasswordHashB, the HomeUSB 210 communicates to the remote system 340, and an error message, e.g. to the effect that the password entered is incorrect, is shown on the remote system 340. Together with the error message, the software application on the remote system 340 prompts the user to enter another password, as shown by step 814. Steps 806 to 810 are then repeated. If the password verification is still not successful after a predetermined number n of failed attempts (e.g. n is equal to 3), the HomeUSB 210 stops communicating with the remote system 340. That is, further verification attempts are no longer possible. With reference to FIG. 6, step 632 then follows.

Advantageously, in embodiments of the present invention, the password hash required for verification is stored on the other module (e.g. PasswordHashB is stored on the HomeUSB 210). Thus, even if an attacker gets access to one module, he cannot mount a dictionary attack and extract the password. Also, as the password information is not stored on a server, but preferably on the modules themselves, an attacker cannot attack the password server to extract the password.

Some portions of the description above are explicitly or implicitly presented in terms of algorithms and functional or symbolic representations of operations on data within a computer memory, or within the systems 100, 200. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “computing”, “calculating”, “determining”, “comparing”, “generating”, “initializing”, “checking”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus, such as system 200, host system 330, remote system 340, for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus, such as, but not limited to systems 100 and 200, to perform the required method steps, may be appropriate. The structure of a conventional general purpose computer will appear from the description below.

In addition, the present specification also implicitly discloses one or more computer programs, in that it would be apparent to the person skilled in the art that the individual steps of the methods described herein may be put into effect by computer code. The various computer programs are not intended to be limited to any particular programming language and implementation thereof. It will be appreciated that a variety of programming languages and coding thereof may be used to implement the teachings of the disclosure contained herein. Moreover, the computer programs are not intended to be limited to any particular control flow. There are many other variants of the computer programs, which can use different control flows, without departing from the spirit or scope of the disclosed embodiments.

Furthermore, one or more of the steps of the computer programs may be performed in parallel rather than sequentially. Such computer programs may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer programs, when loaded and executed on such a general-purpose computer, effectively result in an apparatus that implements the steps of the disclosed methods.

As previously stated, embodiments of the systems 100, 200 may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

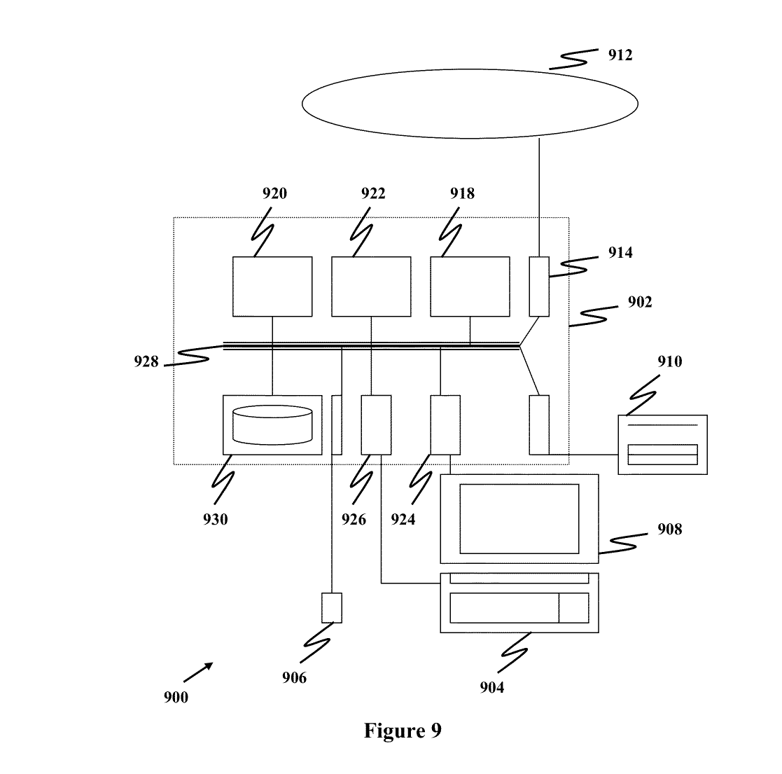

The host system 330 and remote system 340 may be similar to a computer system 900, schematically shown in FIG. 9. They may be implemented as software, such as computer programs being executed within the computer system 900, and instructing the computer system 900 to conduct the methods of the example embodiments. Similarly, portions of the computer system 900 may be embodied in the disclosed systems 100, 200.

The computer system 900 can include a computer module 902, input modules such as a keyboard 904 and mouse 906 and a plurality of output devices such as a display 908, and printer 910.

The computer module 902 can be connected to a computer network 912 via a suitable transceiver device 914, to enable access to e.g. the Internet or other network systems such as Local Area Network (LAN) or Wide Area Network (WAN).

The computer module 902 in the example includes a processor 918, a Random Access Memory (RAM) 920 and a Read Only Memory (ROM) 922. The computer module 902 also includes a number of Input/Output (I/O) interfaces, for example I/O interface 924 to the display 908, and I/O interface 926 to the keyboard 904. The components of the computer module 902 typically communicate via an interconnected bus 928 and in a manner known to the person skilled in the relevant art.

The application program can be supplied to the user of the computer system 900 encoded on a data storage medium such as a CD-ROM or flash memory carrier and read utilizing a corresponding data storage medium drive of a data storage device 930. The application program is read and controlled in its execution by the processor 918. Intermediate storage of program data maybe accomplished using RAM 920.

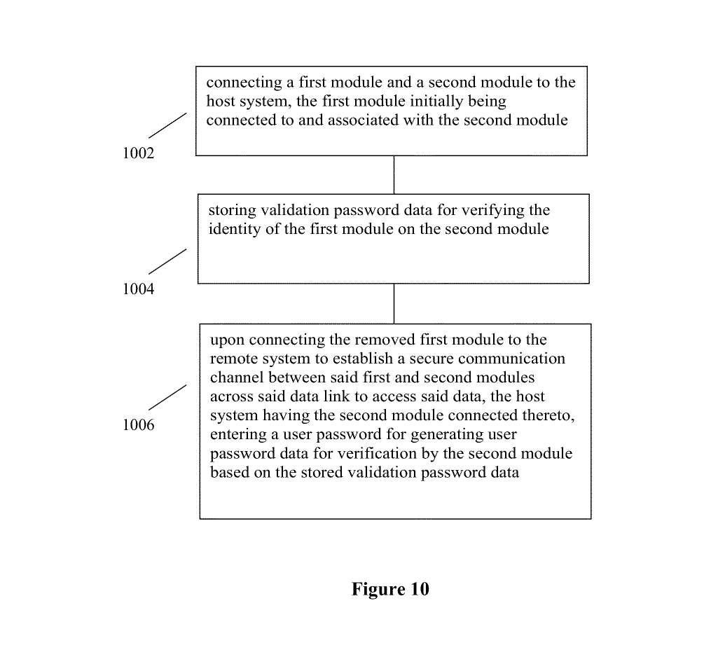

FIG. 10 shows a flow chart 1000 illustrating a method for remote access to data stored on a host system from a remote system via a data link. At step 1002 a first module and a second module are connected to the host system, the first module initially being connected to and associated with the second module. At step 1004, validation password data for verifying the identity of the first module is stored on the second module. At step 1006, upon connecting the removed first module to the remote system to establish a secure communication channel between said first and second modules across said data link to access said data, the host system having the second module connected thereto, a user password is entered for generating user password data for verification by the second module based on the stored validation password data.

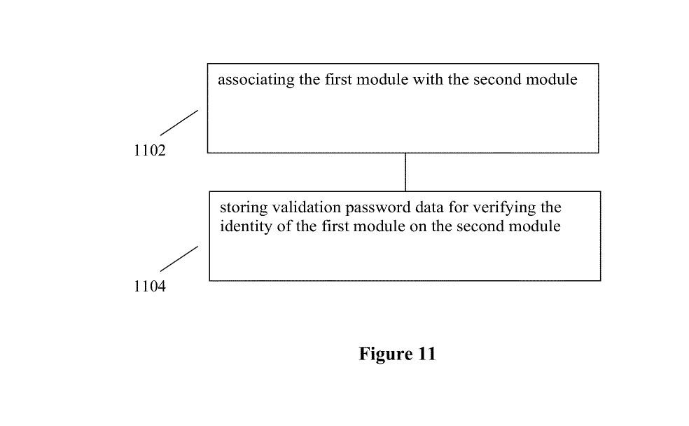

FIG. 11 shows a flow chart 1100 illustrating a method of storing validation password data on a pair of connected first and second modules. At step 1102, the first module is associated with the second module. At step 1104, validation password data for verifying the identity of the first module is stored on the second module.

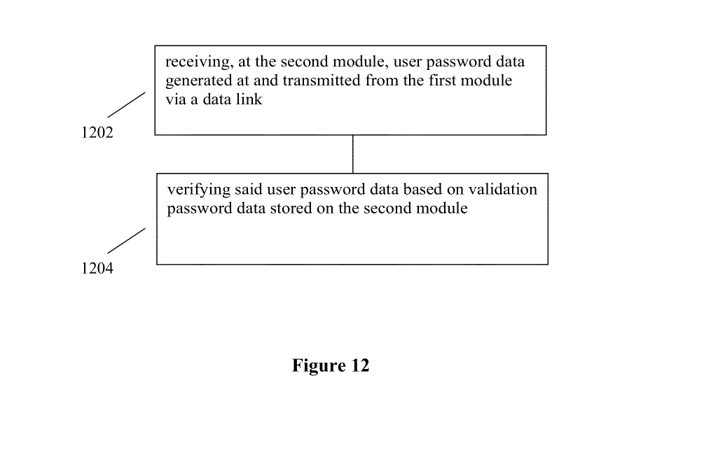

FIG. 12 shows a flow chart 1200 illustrating a method of verifying identity of a first module removed from a pair of initially connected and associated first and second modules. At step 1202, user password data generated at and transmitted from the first module via a data link is received at the second module. At step 1204, the user password data is verified based on validation password data stored on the second module.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

What is claimed is:

1. A method for remote access to data stored on a host system from a remote system via a data link, the method comprising the steps of:
connecting a first module and a second module to the host system, the first module initially being connected to and associated with the second module;
storing validation password data for verifying the identity of the first module on the second module; and
upon connecting the removed first module to the remote system to establish a secure communication channel between said first and second modules across said data link to access said data, the host system having the second module connected thereto, entering a user password for generating user password data for verification by the second module based on the stored validation password data.

2. The method as claimed in claim 1, wherein the step of storing validation password data for verifying the identity of the first module on the second module comprises:
providing a validation password;
generating random first and second SALT values;
calculating a first password hash based on the validation password and the first SALT value, and a second password hash based on the validation password and the second SALT value; and
storing the first SALT value and the second password hash on the second module.

3. The method as claimed in claim 2, wherein the second SALT value and the first password hash are stored on the first module.

4. The method as claimed in claim 2, wherein the step of calculating the first and second password hashes is performed at the host system.

5. The method as claimed in claim 2, wherein the step of calculating the first and second password hashes is performed at either the first module or the second module.

6. The method as claimed in claim 3, wherein generating the user password data comprises calculating a third password hash based on the user password entered and the second SALT value stored on the first module.

7. The method as claimed in claim 6, wherein the verification by the second module comprises:
receiving the third password hash transmitted from the first module via the data link;
comparing the third password hash with the second password hash stored on the second module; and
confirming the identity of the first module only if the third password hash is identical to the second password hash.

8. The method as claimed in claim 7, further comprising entering another user password for another verification attempt if the third password hash is considered not identical to the second password hash by the second module.

9. The method as claimed in claim 8, wherein no further verification attempt is allowed after a predetermined number of failed verification attempts.

10. The method as claimed in claim 2, wherein each password hash is calculated using a respective one-way function.

11. The method as claimed in claim 2, wherein the first and second SALT values each has a length of about 20 bytes.

12. A method of storing validation password data on a pair of connected first and second modules, the method comprising the steps of:
associating the first module with the second module; and
storing validation password data for verifying the identity of the first module on the second module.

13. A method of verifying the identity of a first module removed from a pair of initially connected and associated first and second modules, the method comprising the steps of:
receiving, at the second module, user password data generated at and transmitted from the first module via a data link; and
verifying said user password data based on validation password data stored on the second module.

14. An access system for providing remote access to data stored on a host system from a remote system via a data link, the access system comprising the remote system and the host system, wherein:
the host system is configured to connect to a first module and a second module, the first module initially being connected to and associated with the second module, and to store validation password data for verifying the identity of the first module on the second module; and
the remote system is configured to, upon connecting the removed first module to the remote system to establish a secure communication channel between said first and second modules across said data link to access said data, the host system having the second module connected thereto, enter a user password for generating user password data for verification by the second module based on the stored validation password data.

15. A host system for storing validation password data on a pair of connected first and second modules, the host system configured to associate the first module with the second module; and store validation password data for verifying the identity of the first module on the second module.

16. A host system for verifying the identity of a first module removed from a pair of initially connected and associated first and second modules, the host system configured to receive user password data generated at and transmitted from the first module via a data link; and verify said user password data based on validation password data stored on the second module being connected to the host system.

17. A data storage medium having stored thereon computer code means to instruct a computing device to execute a method of storing validation password data on a pair of connected first and second modules, the method comprising the steps of:
associating the first module with the second module; and
storing validation password data for verifying the identity of the first module on the second module.

18. A data storage medium having stored thereon computer code means to instruct a computing device to execute a method of verifying the identity of a first module removed from a pair of initially connected and associated first and second modules, the method comprising the steps of:
receiving, at the second module, user password data generated at and transmitted from the first module via a data link; and
verifying said user password data based on validation password data stored on the second module.

19. A data storage medium having stored thereon computer code means to instruct an access system to execute a method of providing remote access to data stored on a host system from a remote system via a data link, the access system comprising the remote system and the host system, wherein the method comprises the steps of:
connecting a first module and a second module to the host system, the first module initially being connected to and associated with the second module;
storing validation password data for verifying the identity of the first module on the second module; and
upon connecting the removed first module to the remote system to establish a secure communication channel between said first and second modules across said data link to access said data, the host system having the second module connected thereto, entering a user password for generating user password data for verification by the second module based on the stored validation password data.
